(19) United States
(12) Patent Application Publication
(10) Pub. No.: US 2010/0049398 A1
(43) Pub. Date: Feb. 25, 2010

(54) VEHICLE MOVEMENT PROCESSING SYSTEM

(75) Inventors: Brendan Bryant, Laverton North (AU); Andrew Kitson, Laverton North (AU)

Correspondence Address: LADAS & PARRY LLP, 224 SOUTH MICHIGAN AVENUE, SUITE 1600, CHICAGO, IL, 60604, US

(73) Assignee: RADIO TERMINAL SYSTEMS PTY LTD., Laverton North (AU)

(21) Appl. No.: 12/514,852

(22) PCT Filed: Sep. 25, 2007
(86) PCT No.: PCT/AU2007/001420

§ 371 Date: Sep. 14, 2009

Related U.S. Application Data
(60) Provisional application No. 60/859,233, filed on Nov. 15, 2006.

(51) Int. Cl. G01P 15/00; B60R 21/01

(52) U.S. Cl. 701/33; 701/29

(57) ABSTRACT

A method as system for determining movement of a vehicle by measuring one or more output signals indicative of acceleration of the vehicle along an axis output from one or more accelerometers installed in the vehicle and processing the output signals to produce movement data characterising the movement of the vehicle. The movement data is used to determine whether one or more predetermined movements of the vehicle has occurred.

### FIELD OF THE INVENTION

The technical field of the present invention is vehicle monitoring. An example of an application of the present invention is for determining when an impact has occurred in respect of a vehicle such as a forklift.

### BACKGROUND OF THE INVENTION

In environments such as warehouses there is a need to determine whether impacts or crashes have occurred, for example, for occupational health and safety and insurance purposes.

Known impact sensors for use on vehicles such as forklifts use a pendulum type magnetic inertial switch to trigger an alarm when an impact occurs. Such sensors only trigger at a preset level and require an impact of long duration or significantly high force to trigger. The inertial force experience by the forklift during an impact needs to exceed-a preset threshold to trigger the alarm. This threshold needs to be set at a high level to avoid false triggering by the normal operation of the forklift or noise such as that caused by mast movement, speed bumps or uneven surfaces. The result of setting a high threshold is that only impacts generating a large inertial force will trigger the impact alarm. Alternatively using a lower threshold increases the likelihood of false triggering of the impact alarm.

### SUMMARY OF THE INVENTION

According to one aspect of the present invention there is provided a vehicle movement processing system comprising a movement processor arranged to:
process signals output from one or more accelerometers carried on board a vehicle, each signal indicative of acceleration along an axis, to produce movement data characterising the movement of the vehicle; and
determine whether one or more predetermined movements of the vehicle has occurred based on the movement data.

According to one aspect of the present invention there is provided a vehicle movement processing system comprising:
at least one accelerometer for installation in a vehicle, each accelerometer adapted to output one or more output signals indicative of acceleration on an axis;
a processing system arranged to process the output signals to produce movement data characterising the movement of the vehicle and determine whether one or more predetermined movements of the vehicle has occurred based on the parameter values.

According to another aspect of the present invention there is provided a method of determining movement of a vehicle comprising the steps of:
measuring one or more output signals indicative of acceleration of the vehicle output from one or more accelerometers installed in the vehicle;
processing the output signals to produce movement data characterising the movement of the vehicle; and
determining from the movement data whether one or more predetermined movements has occurred.

Preferably the output signals include a first output signal indicative of acceleration in a first direction and a second output signal indicative of acceleration in a second direction, the second direction being perpendicular to the first direction.

The movement data characterising predetermined movements preferably comprises one or more movement parameter threshold values whereby it is determined whether the predetermined movements have occurred by comparing movement parameter values determined from the movement data processed from the output signals to the threshold values.

Alternatively the movement data characterising predetermined movements can include one or more movement signatures wherein each movement signature comprises the changes over time for the movement of one or more movement parameters. The parameters comprising a movement signature can be determined by measuring the movement parameter values when a vehicle performs the movement.

The movement parameters preferably include one or more of signal amplitude, signal polarity, duration of signal amplitude above a threshold level, signal amplitude decay rate or signal amplitude envelope.

In an embodiment of the system an output signal threshold indicative of normal operating movements of the vehicle can be established such that output signals exceeding the threshold value trigger the processing of the output signals to provide movement data for the vehicle. The output signal threshold may be variable.

Preferably the system includes two accelerometers arranged in a single plane with the first and second directions of the second accelerometer at a 45° angle relative to the first and second direction of the first accelerometer.

The communication interface may be provided as a wireless communication interface enabling data to be transmitted to a remote processor or user interface during operation of the vehicle.

In one embodiment of the system the movement processing system comprises a data reception part adapted to receive the output signals from the accelerometer and a data processing part adapted to analyse the movement data. The data processing part can be external to the moving vehicle and the reception part adapted to transmit movement data to the data processing part using the communication interface.

Movement data can be stored in the reception part for download at a predetermined time.

The sensor system may include further optional features such as one or more of:
one or more alarms to indicate to a vehicle operator that a predetermined movement designated as dangerous has occurred;
an interface to a control system of the vehicle adapted to limit or prevent further operation of the vehicle after one or more predetermined movements designated as dangerous have occurred;
a function in the processing system to provide warning data to indicate when each movement designated as dangerous occurred;
a means for determining the identity of the vehicle operator and associating movement data for the vehicle with the vehicle operator identity at the time the movement data was measured; and
a location sensor to enable the location where a movement occurred to be associated with the movement data.

For example when a movement designated as dangerous has occurred one of more of the following steps may be executed:
triggering one or more alarms;
providing warning data;
controlling the vehicle to limit or prevent further operation of the vehicle;
recording the identification of the vehicle operator at the time the movement occurred; and
recording the location where the movement occurred.

### BRIEF DESCRIPTION OF THE DRAWINGS

FIG. 1 is a functional block diagram of an embodiment of the present invention.

FIGS. 2a to 2c illustrate the orientation of two accelerometers used in a preferred embodiment of the invention.

FIG. 3 is a functional block diagram of a preferred embodiment of the present invention.

FIGS. 4a to 4f illustrate signal waveforms output from an accelerometer.

### DETAILED DESCRIPTION

The movement processing system according to embodiments of the present invention comprises a movement processor arranged to process signals, each indicative of movement along an axis, output from one or more accelerometers carried on board a vehicle to provide movement data characterising the movement of the vehicle. Based on the movement data the processor can determine whether one or more predetermined movements of the vehicle has occurred.

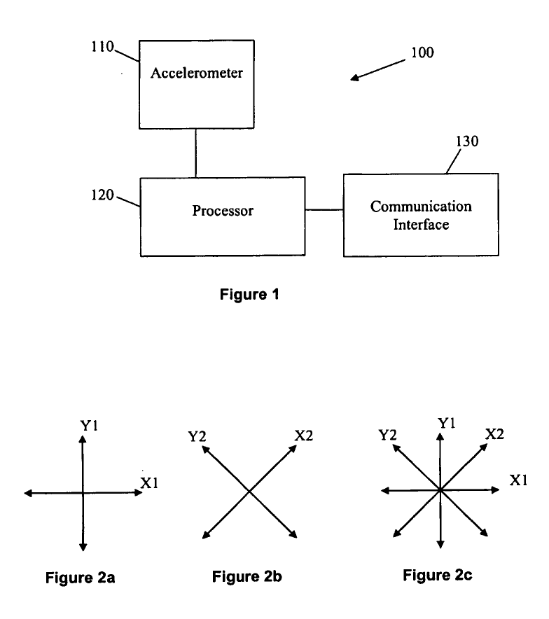

The movement processing system 100 as shown in FIG. 1 includes at least one accelerometer 110 for installation in a vehicle, a movement processing system 120 and an optional communication interface 130. Each accelerometer 110 is adapted to output one or more output signals indicative of acceleration. Movement data characterising the actual vehicle movement is extracted from the output signals for analysis by the processing system 120. The movement data characterising the actual movement is compared with movement data characterising predetermined movement to determine whether one or more predetermined movement has occurred. The optional communication interface 130 is adapted for installation on the vehicle to enable movement data to be transmitted to the processing system if the data analysis is performed external to the vehicle and/or to provide information to a control centre, supervisor or the like when a movement of interest has occurred.

The predetermined movements can include a number of movements of interest to the operator of the vehicle or manager of the environment in which the vehicle is used. Typically the movements of interest will be those associated with unsafe operation of the vehicle or which risk damage to goods, for example impacts, too rapid acceleration and deceleration, jerky or erratic movements.

The types of movement of interest can change depending on the environment in which the system is used also the extremity of the movement could influence whether it is of interest or not. For example, in a warehouse environment where a forklift is moving loaded pallets of goods some small impacts, such as when the forks are inserted into the pallet and the vehicle lightly bumps the pallet, may be considered an acceptable or allowable impact as only small forces and vibrations are involved, whereas collision between a moving forklift and a fixed object, such as shelving, would generally be a harder impact of longer duration with greater, potentially damaging, forces involved. The movement data charactering an actual movement can be used to distinguish between movements within an allowable range and movements not allowable based on the comparison of movement data with reference movement data characteristic of predetermined movements of interest.

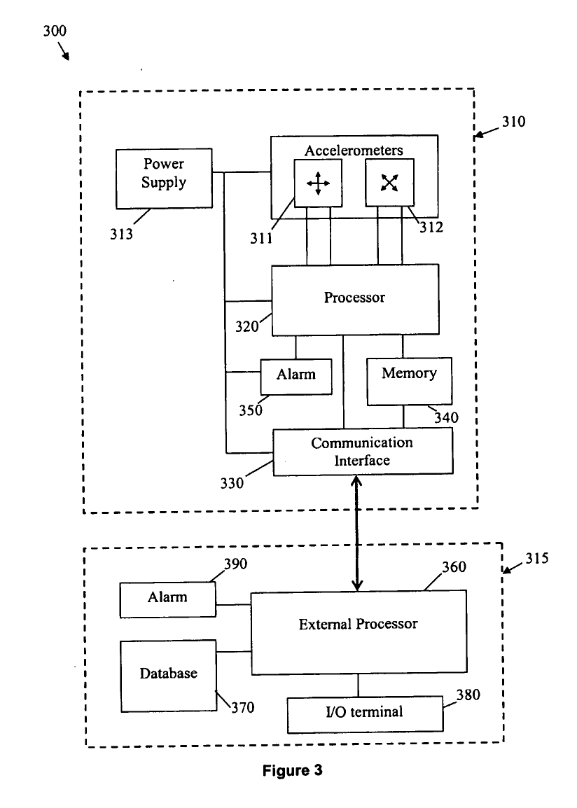

A preferred embodiment of the sensor system will now be described with reference to the block diagram of FIG. 3. The preferred embodiment of the system 300 comprises subsystem 310 for installation in the vehicle and an external subsystem 315 which could be a control centre or the like. The vehicle subsystem 310 includes two accelerometers 311 and 312, a processor 320, communication interface 330, memory 340, alarm 350 and power supply 315. The external subsystem includes an external processor 360, a database 370, and input output terminal 380, and optional alarm 390. Data is transmitted between the vehicle subsystem and the external subsystem via the communication interface 330.

The accelerometers used in the preferred embodiment of the present invention measure the acceleration along two right angled axes X1 and Y1 as shown in FIG. 2a. The polarity of the output voltage is indicative of whether the detected motion is acceleration or deceleration along the axis and the magnitude of the voltage is proportional to the rate of acceleration. An example of a suitable accelerometers available at the time of writing this specification is the Motorola MMA6200 series capacitive accelerometers. The Motorola MMA6230Q X-Y axis sensitivity micro-machined integrated-circuit accelerometer is a member of this series. The MMA6230Q series outputs two voltage signals, the first voltage signal indicative of inertial force experienced by the accelerometer in the X axis direction and the second indicative of inertial force in the Y axis direction, the X and Y axes are perpendicular to each other. This is merely one example of a suitable accelerometer, it should be understood by a person skilled in the art that other types of accelerometers could be used.

Rotating one accelerometer by 45° provides movement data measurements in directions mid way between those measured by the first accelerometer, an example of the axes X2 and Y2 of the 45° rotated accelerometer is shown in FIG. 2b. The preferred embodiment of the invention uses two MMA6230Q accelerometers arranged at 45° relative to each other in the same plane. An example of the arrangement of the axes X1, Y1, X2 and Y2 is shown in FIG. 2c. The advantage of this arrangement is that data for 8 directions is measured simultaneously thus significantly reducing the processing time required to analyse a 360° model for the detected motion.

As shown in FIG. 3 the preferred embodiment of the motion sensor system 300 includes two accelerometers 311 and 312. The accelerometers are arranged both in the same plane but with the measuring axes of the second accelerometer 312 angled 45° relative to the axes of the first accelerometer 311. The voltage output from each accelerometer X1, Y1, X2 and Y2 is input to the processor 320.

The voltage signals are indicative of movement in 8 directions enabling 360° movement analysis from the voltage signals. The movement data analysis can include:
filtering out movements below a predetermined impact threshold;
filtering out movements where parameters characterising the movement signature fall within allowed parameter ranges;
filtering out movements which have a duration or magnitude that does not resemble the shockwave of an impact or other movement of interest;
comparing measured movement parameters with known movement signatures for specific movements of interest; and
identifying movements which appear abnormal based on movement signatures or preset parameters.

The data is then converted to a form suitable for storage or output to a user.

When the vehicle is moving signals indicative of the acceleration of the vehicle are measured by the accelerometer and output as voltage signals. In the preferred embodiment of the invention the processor 320 receives these voltage signals via analogue to digital converting input ports.

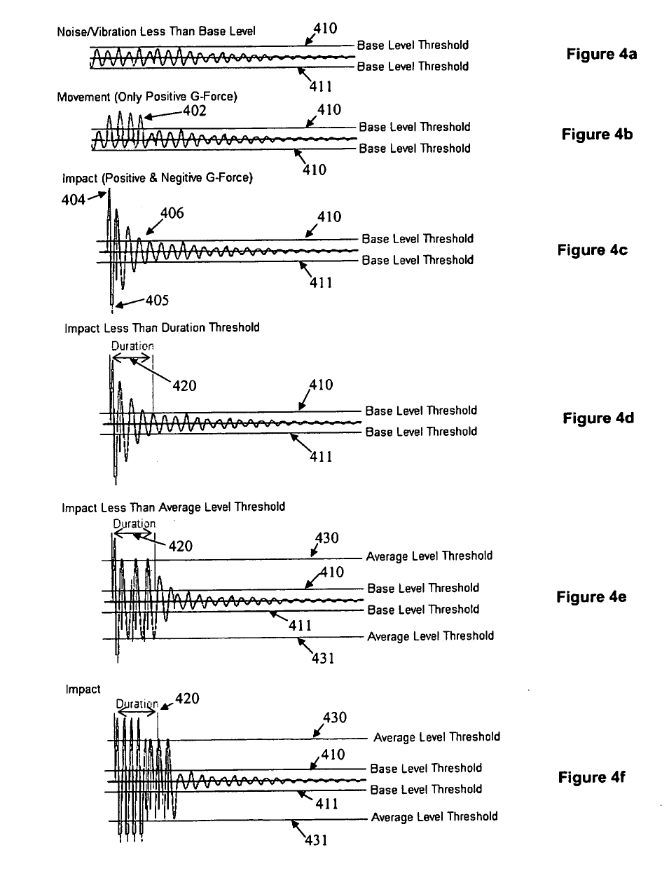

Examples of the output signals indicative of movement along one measurement axis are shown in FIGS. 4a to f, for example positive signal values indicate acceleration in the forward direction and signal negative values indicate acceleration in the backwards direction or deceleration of the vehicle.

FIG. 4a is an example of normal noise and vibration of the vehicle, for example engine vibration, positive and negative base level threshold 410, 411 can be set to filter out these normal vibrations so the analysis of the movement data is triggered by a signal amplitude exceeding this base threshold level. FIG. 4b shows an example of the signal output when the vehicle is moving forward. As can be seen in FIG. 4b at 402 the signal amplitude increases and exceeds the positive threshold value 410 but not the negative threshold value, indicating acceleration in the forward direction only.

FIG. 4c is an example of the output signal for an impact. The signal shows acceleration components in both the positive direction 404 and the negative direction 405 which initially exceed both the positive base threshold value 410 and the negative base threshold value 411 and then the vibrations from the impact rapidly decay to below the positive and negative threshold values as the forces operating on the accelerometer from the impact dissipate. Several parameters measured from the impact waveform, such as the peak amplitude, duration, and decay rate, can be used to determine the extent of the impact and based on the environment determine the likelihood of damage being caused.

An example of using threshold values to determine whether a damaging impact has occurred will now be described with reference to FIGS. 4d to 4f. In this example a potentially damaging impact is determined based on two parameters, the impact duration and the signal amplitude which are each compared against a duration threshold value and an average impact amplitude level threshold. For example an impact where significant forces are applied for a sufficient period of time may result in damage and hence be of interest. The thresholds can be set to predetermined values, for example based on guidelines form an operator's manual. Alternatively the threshold values may be calibrated by the operator based on testing and measuring actual impacts and using observation of the results of impacts, such as damage, to determine which impacts are of interest. The measured impact waveforms are indicative of the forces applied to the accelerometer during the impact so from the measured impact waveforms threshold values for the duration and amplitude of impacts of interest may be determined.

FIG. 4d illustrates an impact signal waveform where the impact is of a shorter duration than the duration threshold 420. As can be seen in FIG. 4d the forces from the impact dissipate to within the normal base level, as indicated by the decay in the signal amplitude, in less time than the impact duration threshold, so this signal would not be regarded as indicating an impact of interest.

FIG. 4e illustrates an impact signal waveform where the impact duration is longer than the impact duration threshold 420. Next the signal amplitude for the duration is analysed to determine whether the signal amplitude exceeds the predetermined amplitude threshold and for how long. For example, as shown in FIG. 4e the impact signal initially exceeds an amplitude threshold set at the average impact level. The average impact level may be indicative of regularly experienced impacts say due to loading or unloading of a forklift. If the signal amplitude remains below the amplitude threshold for all or a significant portion of the duration, this indicates that the impact is not an impact of interest and is within the expected operation of the vehicle.

FIG. 4f illustrates an impact signal which exceeds the duration threshold and the signal amplitude exceeds the amplitude threshold value for a significant portion of the duration, so would be identified as an impact of interest based on the comparison of the impact signal to the threshold values.

The base threshold level may be calibrated by the operator for the particular vehicle or set based on manufacturer's guidelines. For example, for an electric motor driven forklift very little vibration is likely to be experienced during normal operation so the base threshold level may be set much lower than that of a gas forklift. The average level of impacts of interest may be set relative to the base level, say 20% above the base level, or at a level determined through calibration. An example of manufacturers guidelines for setting of base and average threshold levels are given in table 1.

| | Base threshold | Average threshold |
|---|---|---|
| | level (scale of 0 | level (scale of 0 |
| Vehicle type | to 10) | to 10) |
| 1.3 ton reach | 1.0 | 2.5 |
| truck | | |
| 2.0 ton electric | 0.5 | 0.5 |
| forklift | | |
| 4.5 ton gas | 1.0 | 2.0 |
| forklift | | |
| 1.3 ton reach | 1.0 | 3.0 |
| truck | | |

As shown in table 1, where the vehicle makes little noise during normal operation, such as the electric forklift, the base and average threshold level may be set to the same level such that any impact where the average amplitude of the signal exceeds the base level for the threshold duration is an impact of interest. Similarly two different settings could be tried for the same vehicle, such as is shown for the 1.3 ton reach truck. For example, if the truck is new a lower average threshold level may be used compared to an older truck where more false impact triggers due to vehicle fatigue may occur. The threshold levels may also be varied over time due to aging of the vehicle resulting in higher levels of noise movement during regular operation.

Alternative means of determining whether a signal is of interest can include comparison of the signal waveform with that of a signal waveform characteristic of a particular movement referred to as a movement signature. For example, the difference between a small and large impact can be clearly seen by a visual comparison of the signal waveforms of FIG. 4c and FIG. 4f. In particular the signal envelope, determined from the signal amplitude values, of 4c shows an initial high amplitude and gradual decay over time to an amplitude below the base threshold level. However, in FIG. 4f the envelope shows high amplitude values for a significant duration then a rapid decay to below the base threshold level. Thus the shape of the signal envelope is indicative of the type of impact. A movement signature can include values for a number of parameters including maximum signal amplitude, signal envelope, duration, signal polarity, signal amplitude decay rate etc. A movement signature may also be characterised as having different values along different axes for the various parameters. The parameter values may be relative or actual parameter values for each axis.

The example shown in FIGS. 4a to 4f shows only one output signal, indicative of forces measured by the accelerometer along one axis only. Where the accelerometer measures forces along more than one axis or multiple accelerometers are used, enabling measurement of forces along a number of axes, a similar analysis of the signal can be performed for output signals indicative of forces along each axis. Comparison on the signals from each axis enables the sensor system to determine the direction of the impact and the forces experienced from multiple directions during the impact. Thus, where the axes are all in the one plane a 360° model of the impact can be generated. Alternatively if vertical as well as horizontal movement is of interest, for example monitoring movements and impacts for a container of fragile goods which may be loaded by a crane as well as a forklift, the accelerometers may be arranged with axes in a first plane for measuring horizontal movement and in a second plane, perpendicular to the first plane, for measuring vertical movement enabling a three dimensional movement model to be generated.

Comparison of the movement data from measured signals for a movement with a known movement signature requires more data processing resources than comparison of movement data from measured signals with threshold values, thus the signal analysis method can be varied depending on the data processing capabilities of the system. Alternatively two data processing schemes can be employed where signals are analysed both in real time and non-real time or batch processing. For example, in a training environment it may be important in real time to provide warnings for dangerous movements or impacts which may be analysed based on thresholds. However, signal data may also be stored for subsequent detailed analysis of movements based on movement signatures for determining the level of skill of the trainee and providing feedback. This subsequent analysis is not constrained by the same processing speed requirements as the real time processing thus more sophisticated analysis may be performed.

Providing more axes for measurement of movement signals enables the processing time and resources required to be reduced. Firstly, by measuring forces along a number of axes more data is measured by the accelerometer requiring less analysis to extrapolate data to determine from which direction an impact occurred. Secondly, where limited processing resources are available the movement data can be selectively analysed from one or more axes of interest, for example the axes with the highest measurements which enables the impact direction also to be determined using minimal processing.

Further, the movement processing system can determine whether the vehicle is moving or stationary before the impact using either previous movement data or a further signal, for example from the vehicle control system such as a speed meter reading or accelerator control signal.

In the preferred embodiment the analysis of the movement data is performed by processor 320 installed on-board the vehicle. The processor 320 can be programmed to identify particular kinds of movement events, for example: impacts, rapid acceleration or sudden stops which may be of interest.

The analysis can provide data including the type of movement event, the magnitude and direction of forces experienced during the event, and the duration of the event. To this data the processor can add other information, such as the time, date, identity of the operator, vehicle identifier and the like, for reporting or storage of the movement event. The methods used for signal analysis can be varied depending on the processor capabilities. The movement event data may be output to the driver, for example using a monitor screen installed in the vehicle or announcement device, as well as being stored in a data logger for downloading at a later time, for example using an RS232 interface or the like.

Movement events can be reported in real time to a monitoring station external to the vehicle using a communication interface such as a wireless LAN or radio frequency communication such as Bluetooth. Similarly the movement event data may be downloaded to the external monitoring station on demand.

The processor can also be programmed to perform other functions when particular movement events are detected such as sounding an alarm or triggering some other alert to information driver and/or others that an event such as an impact has occurred. Alternatively or for certain events, such as high force impacts likely to cause damage, the processor may shut down the vehicle to prevent further operation or limit the subsequent operation of the vehicle, for example limiting speed or only enabling operation by a supervisor or mechanic to move the vehicle if the impact is of a magnitude likely to cause damage.

In the preferred embodiment the analysis of the movement data is performed by processor 320 installed in the vehicle. Alternatively movement data can be output to an external processor 360 for analysis. Where the movement data is externally analysed the on-board processor 320 forwards recorded movement data along with associated information such as time and date information to the external processor via the communication interface 330, such as a wireless LAN or radio frequency transceiver. Alternatively the data may be stored in memory 340 for subsequent download and analysis, for example at the end of a shift or training session. The data stored or forwarded may be raw data or some preliminary processing may be performed by the on-board processor, such as discarding measured results which are below a predetermined threshold and have an very low probability of relating to an impact or other event of significance which is being monitored.

Power to the vehicle subsystem can be provided either by using an internal power supply such as a battery or draw power from the vehicle battery. Where power is drawn from a vehicle battery the apparatus will also comprise battery connection and power regulation circuitry. The actual configuration or source for the power supply 315 is not critical to the invention.

It should be understood that the present invention enables more detailed data to be gathered in relation to movement events such as impacts than was previously possible. Further, the movement data has greater relevance to abnormal or significant movements as the movement data is filtered to remove the noise of normal movements of the vehicle from the data.

It is desirable to gather information regarding impacts or movements of vehicles or equipment for occupational health and safety purposes, also for driver performance and training purposes. For example, in a warehouse environment, forklift impacts indicate careless driving or safety problems as well as being potentially damaging to goods, equipment, and people. Also erratic driving, rapid acceleration and deceleration, or taking corners too fast may also be potentially hazardous, particularly to people in an environment such as a warehouse. The ability to obtain objective data regarding the equipment's movement and hence the driver's performance is a useful tool for performance management and training for drivers. Further the recoded movement data can be useful when investigating any incidents where goods are damaged or people injured.

The system may include an identification module, such as an identity card or proximity card reader or other means to record and track identification information for the vehicle operator. The identification of the operator may be linked to the movement data recorded. The identification module may be linked to the control of the vehicle so that only an authorised operator can operate the vehicle. Similarly the system may revoke an operator's authorisation if they are determined to be dangerous or dangerously operating the vehicle based on analysed movement data.

The system may also include functionality to determine the location of the vehicle when movements of interest or impacts occur. This could include an additional positioning module, such as a Global Positioning System (GPS) or similar navigation system to provide an accurate location, or the location may be isolated to a particular region of a working space based on the wireless communication signal. For example, the wireless LAN base station is receiving the strongest signal from the system is most likely the base station in the warehouse area where the vehicle is working, enabling an approximate location to be determined. The location information can be associated with the impacts or movements of interest to alert supervisors or emergency response crews to where a dangerous event has occurred or to track where impacts have occurred for inspection and maintenance and highlight problems, for example areas poorly designed for maneuvering the vehicle resulting in impacts occurring repeatedly in the same area.

Additional sensors may also be included in the system to measure additional movement data. For example, gyroscopic sensors or additional inertial sensors, to determine tilt, elevation, or rotation may be added. The signals received from the additional sensors can be analysed to provide further detail regarding movement of the vehicle.

The movement processing system could be used in any application where it is required to measure impact or abnormal movements for identifying damage or safety related reasons, for example such applications in include: trucks, trains, trams, buses, materials handling equipment, earthmoving equipment, catering equipment for aeroplanes and mining equipment. The monitoring function could also be combined with other technology. For example by combining logging movement data from a train or tram in combination with location information, such as provided by global positioning system (GPS) readings, areas of the tracks which are damaged or causing potentially dangerous abnormal movement of carriages could be identified and the relevant authority or maintenance department automatically warned, enabling investigation and repair or other preventative action to be taken to minimise any accident risk.

1. A vehicle movement processing system comprising a movement processor arranged to:
process signals output from one or more accelerometers carried on board a vehicle, each signal indicative of acceleration along an axis, to produce movement data characterising the movement of the vehicle; and
determine whether one or more predetermined movements of the vehicle has occurred based on the movement data.

2. A system as claimed in claim 1 wherein the movement data characterising the movement of the vehicle comprises one or more parameter values.

3. A system as claimed in claim 2 wherein the parameter values include one or more of signal amplitude, signal polarity, duration of signal amplitude above a threshold level, signal amplitude decay rate or signal amplitude envelope.

4. A vehicle movement processing system comprising:
at least one accelerometer for installation in a vehicle, each accelerometer adapted to output one or more output signals indicative of acceleration on an axis;
a movement processing system arranged to process the output signals to produce movement data characterising the movement of the vehicle and determine whether one or more predetermined movements of the vehicle has occurred based on the movement data.

5. A system as claimed in claim 4 wherein the output signals include a first output signal indicative of acceleration in a first direction and a second output signal indicative of acceleration in a second direction, the second direction being perpendicular to the first direction.

6. A system as claimed in claim 4 wherein movement data characterising the predetermined movements includes one or more movement parameter threshold values whereby it is determined whether the predetermined movements have occurred by comparing the movement data processed from the output signals to the threshold values.

7. A system as claimed in claim 4 wherein movement data characterising the predetermined movements includes one or more movement signatures wherein each movement signature comprises the change of one or more movement parameter values over time during the movement.

8. A system as claimed in claim 7 wherein the parameters comprising a movement signature are determined by measuring the movement parameter values when a vehicle performs the movement.

9. A system as claimed in claim 7 wherein the movement parameters include one or more of signal amplitude, signal polarity, duration of signal amplitude above a threshold level, signal amplitude decay rate or signal amplitude envelope.

10. A system as claimed in claim 4 wherein an output signal threshold value indicative of normal operating movements of the vehicle is established such that output signals exceeding the output signal threshold value trigger the analysis of the output signals to process movement data for the vehicle.

11. A system as claimed in claim 10 wherein the output signal threshold value is variable.

12. A system as claimed in claim 4 wherein the system includes two accelerometers arranged in a single plane with the first and second directions of the second accelerometer at a 45° angle relative to the first and second direction of the first accelerometer.

13. A system as claimed in claim 4 wherein the movement processing system comprises a data reception part adapted to receive the output signals from the accelerometer and process movement data and a data processing part adapted to determine whether one or move predetermined movements has occurred.

14. A system as claimed in claim 13 further comprising a wireless communication interface enabling movement data to be transmitted to a remote processor or user interface during operation of the vehicle.

15. A system as claimed in claim 14 wherein the data processing part is external to the moving vehicle and the reception part is adapted to transmit movement data extracted from the output signals to the data processing part using the communication interface.

16. A system as claimed in claim 13 wherein the movement data is stored in the reception part for download at a predetermined time.

17. A system as claimed in claim 4 further comprising one or more of:
one or more alarms to indicate to a vehicle operator that a predetermined movement designated as dangerous has occurred;
an interface to a control system of the vehicle adapted to limit or prevent further operation of the vehicle after one or more predetermined movements designated as dangerous have occurred; and
a function in the processing system to provide warning data to indicate when each movement designated as dangerous occurred.

18. A system as claimed in claim 4 further comprising a means for determining the identity of a vehicle operator and associating movement data for the vehicle with the vehicle operator identity.

19. A system as claimed in claim 4 further comprising a location sensor to enable the location where a movement occurred to be associated with the movement data.

20. A method of determining movement of a vehicle comprising the steps of:
measuring one or more output signals indicative of acceleration of the vehicle output from one or more accelerometers installed in the vehicle;
processing the output signals to produce movement data characterising the movement of the vehicle; and
determining from the movement data whether one or more predetermined movements has occurred.

21. A method as claimed in claim 20 wherein the output signals include a first output signal indicative of acceleration in a first direction and a second output signal indicative of acceleration in a second direction, the second direction being perpendicular to the first direction.

22. A method as claimed in claim 20 wherein movement data characterising the predetermined movements comprises one or more movement parameter threshold values and wherein the step of determining whether the predetermined movements have occurred includes comparing the movement parameter values determined from the movement data to the threshold values.

23. A method as claimed in claim 20 wherein movement data characterising the predetermined movements comprises one or more movement signatures wherein each movement signature comprises the changes over time for the movement of one or more movement parameters and wherein the step of determining whether the predetermined movements have occurred includes comparing changes of movement parameter values over a time period determined from the movement data to the changes the movement parameter values of the movement signature.

24. A method as claimed in claim 23 further comprising the step of determining a movement signature by measuring one or more movement parameter values during a vehicle performing the movement.

25. A method as claimed in claim 24 wherein the movement parameters include one or more of signal amplitude, signal polarity, duration of signal amplitude above a threshold level, signal amplitude decay rate or signal amplitude envelope.

26. A method as claimed in claim 20 further comprising a steps of:
establishing an output signal threshold value indicative of normal operating movements of the vehicle; and
triggering processing of the output signals to produce movement data for the vehicle when measured output signals exceed the output signal threshold value.

27. A method as claimed in claim 26 wherein the output signal threshold is variable.

28. A method as claimed in claim 20 further comprising the step of transmitting movement data to a processor external to the vehicle and the external processor performing the determining step.

29. A method as claimed in claim 20 further comprising the step of storing movement data extracted from output signals for download at a predetermined time.

30. A method as claimed in claim 20 further comprising carrying out one or more of the following steps if a predetermined movement designated as dangerous has occurred:
triggering one or more alarms;
providing warning data;
controlling the vehicle to limit or prevent further operation of the vehicle;
recording the identification of the vehicle operator at the time the movement occurred; and
recording the location where the movement occurred.
